(19) United States
(12) Patent Application Publication
(10) Pub. No.: US 2009/0270233 A1
(43) Pub. Date: Oct. 29, 2009

(54) Dumbbell Handle Assembly and Method of Production

(76) Inventor: Guofang Cao, Diamond Bar, CA (US)

Correspondence Address: LAW OFFICES OF J.F. LEE, 17800 CASTLETON STREET, SUITE 383, CITY OF INDUSTRY, CA, 91748, US

(21) Appl. No.: 12/109,962

(22) Filed: Apr. 25, 2008

(51) Int. Cl. A63B 21/072; B23P 11/00

(52) U.S. Cl. 482/108; 29/428

(57) ABSTRACT

Dumbbell handle bar assembly and method of production is presented, wherein the traditional way of machining down the thickness (exterior diameter) of a handle bar from that of the collar is avoided, resulting in substantial saving of material, such as steel or any metal alloy, and saving of time needed to machine off the amount of material, by using collar-nuts having inner threadlines that can be snugly fit to the threaded junction areas defining the central grip portion.

### FIELD AND BACKGROUND OF THE INVENTION

The present invention relates generally to construction of dumbbell handle and the method of such construction used on fitness training equipment.

The handle bar of traditional dumbbells that can load variable weights contains two collars flanking a central grip portion, with two outer stub portions capable of attaching variable weight heads or weight discs.

The production of such traditional handle bar is done by taking a length of cylindrical bar of proper material such as metal or steel, and proceed to machine off the thickness (diameter on the exterior of such bar), until the two collars are formed, defining the central grip in between and the two loading ends, referred to as “stub” in present application.

A lot of material waste is produced in such process, which is also time-consuming.

Present invention substantially reduces the wasted material due to the old machining down process, and also saves a lot of time.

### OBJECTS AND SUMMARY OF THE INVENTION

Present invention takes a cylindrical bar of proper material and machines down just a little bit of the thickness (exterior diameter) on the two stub portions and by creating threadlines for inserting two color-nuts, resulting in substantial saving in the material and the time needed to produce such a handle bar.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows a traditional dumbbell handle bar having drilled/tapped holes on the two stubs.

FIG. 2 shows a traditional dumbbell handle bar having threaded end on the two stubs.

FIG. 3 shows the dumbbell handle bar of present invention, with the two collar-nuts spread out.

FIG. 4 shows an assembled view of the dumbbell handle bar of present invention.

### DETAILED DESCRIPTION OF THE PREFERRED EMBODIMENT

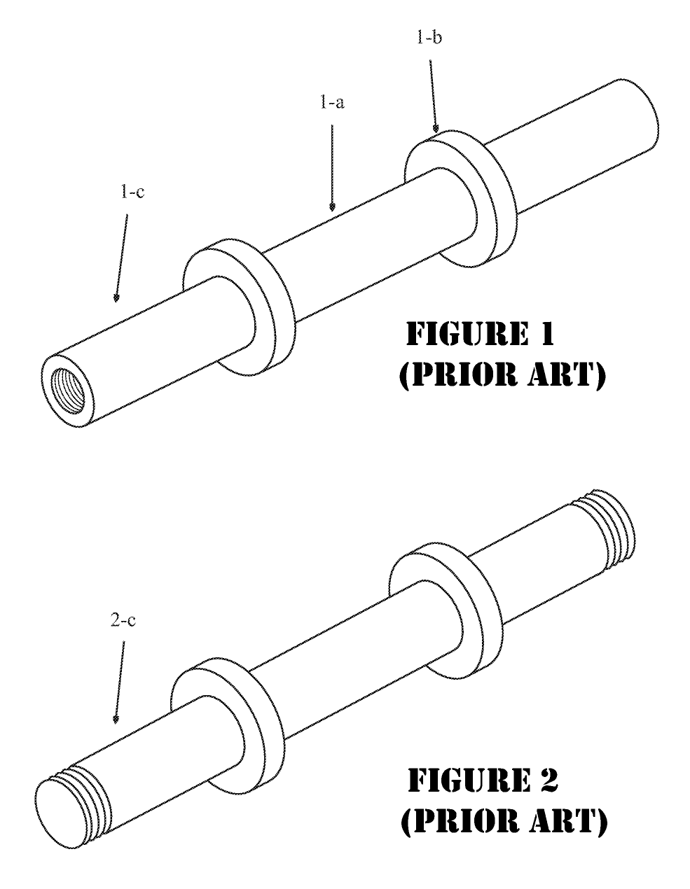

In FIG. 1, a traditional dumbbell handle bar is shown.

To make this type of handle bar, a length of bar having the diameter of 1-b, the place of the collars, is fed into a machine wherein the thickness (exterior diameter) of the central grip portion 1-a and the two stubs 1-c are machined off and down to the desired size. A lot of the metal material is wasted as a result of the machining down. It is also time-consuming.

Depending on the chosen configuration, the end of the two stubs can be made to a drilled hole with inner thread, as in FIG. 1, or made to contain outer threadline, as in FIG. 2, for attaching locking nuts to keep the selected weight heads or weight discs in place.

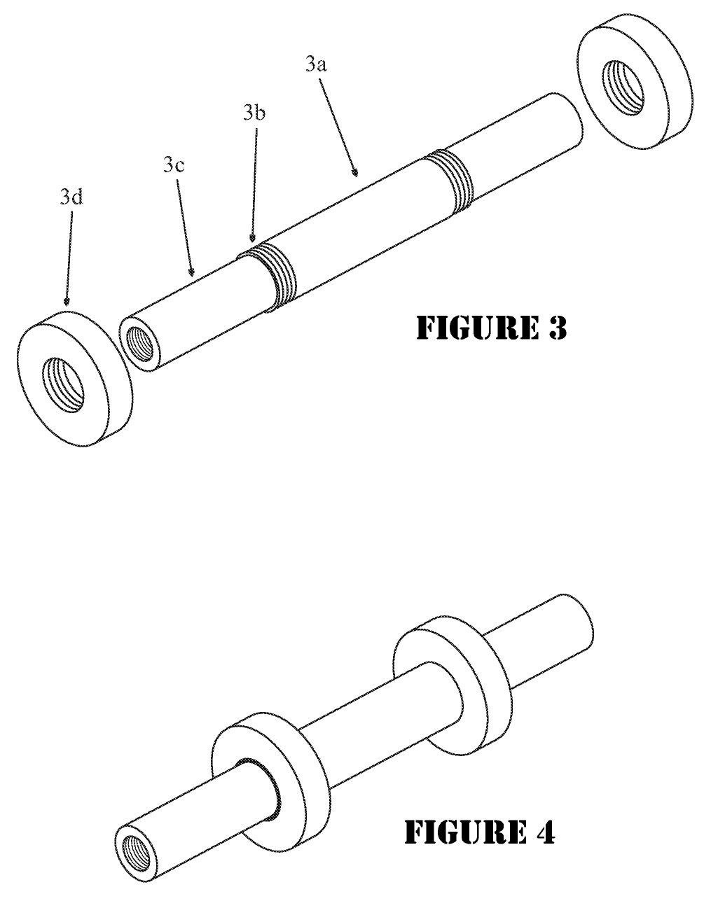

With present invention, a handle bar is slightly machined down on the two stub 3c, as shown in FIG. 3, so that weight heads and weight discs can be inserted from the two stubs 3c.

The two junction areas 3b between central grip portion 3a and stubs 3c will be made into thread line configuration for receiving two collar-nuts 3d. Essentially, 3b will maintain the same diameter as that of grip portion 3a.

Alternatively, diameter of the threaded portion 3b can also be made to be slightly smaller than that of central grip portion 3a, producing a stop-action when the collar-nuts 3d are inserted (screwed) in place.

The inner diameter of collar-nuts 3d is the same as the junction 3b thread line, so that when the two collar-nuts 3d are screwed in and assembled in place, they form a snug fig collar to define and guard the central grip portion 3a, as shown in FIG. 4, the assembled view of present invention.

Actual production showed that the handle bar made pursuant to the disclosure of present invention substantially reduces the waste material and saves a lot of the time needed for machining down the thickness/diameter for the central grip portion and the two stub portions.

What is claimed is:

1. Dumbbell handle bar assembly, comprising:
a. A bar having a central grip portion;
b. Two threaded junction areas made to the two ends of said central grip portion;
c. Two stub portions coaxially connected to the two said threaded junction areas and the diameter of said stub is made slightly smaller than that of the threaded junction area; and,
d. Two collar-nuts having inner diameter with thread lines fitted to said junction areas.

2. The dumbbell handlebar assembly of claim 1, wherein the diameter of threaded junction areas is made to be slightly smaller than that of the central grip portion, and the stub portion is made to be slightly smaller than that of the threaded junction areas.

3. Method of producing dumbbell handle bar, comprising:
a. Take a cylindrical bar of suitable material and machine down the diameter of the two stub portions;
b. Machine and produce two threaded junction areas between the central grip portion and the two stub portion; and,
c. Attach two collar-nuts having inner threadlines fitted to the threadlines on the junction area on the handle bar.

4. The method of producing dumbbell handle bar of claim 3, further having the step of making the diameter of the threaded junction area slightly smaller than that of the central grip portion, and making the diameter of the stub portion slightly smaller than that of the junction area, with the collar-nuts having inner diameter of its threadline fitting to the threadline of the junction area.
